(19) United States
(12) Patent Application Publication
(10) Pub. No.: US 2020/0149683 A1
(43) Pub. Date: May 14, 2020

(54) SAFETY SYSTEM FOR A PRESSURE ACCUMULATOR

(71) Applicant: HYDAC TECHNOLOGY GMBH, Sulzbach/Saar (DE)

(72) Inventors: Thomas KREUTZER, Merchweiler (DE); Thomas GOETZ, Merchweiler (DE)

(21) Appl. No.: 16/634,599

(22) PCT Filed: Aug. 9, 2018
(86) PCT No.: PCT/EP2018/071644

§ 371 Date: Jan. 28, 2020

(30) Foreign Application Priority Data
Aug. 12, 2017 (DE) 10 2017 007 628.6

(51) Int. Cl. F17C 13/04; F15B 20/00; F15B 21/00; F15B 1/08

(52) U.S. Cl. CPC F17C 13/04; F15B 20/00; F15B 21/005; F15B 1/08; F15B 2211/41; F15B 2211/50518; F17C 2205/0329; F17C 2221/014; F17C 2205/0385; F15B 2211/8757; F17C 2205/0332

(57) ABSTRACT

A safety system comprising a valve block (10) to which at least one gas safety valve (12, 14) is connected in a preferably detachable manner, having at least one controllable valve (50, 52, 58) in or at the valve block (10) and having at least one pressure accumulator (42) holding a gaseous pressure medium, which pressure accumulator is connected to the valve block (10) in a likewise detachable manner, is characterized in that a gas-conveying connection routed at least partially within the valve block (10) between the connected pressure accumulator (42) and the connected gas safety valves (12, 14) can be opened or blocked by means of the valve (50, 52, 58).

The invention relates to a safety system having a valve block to which at least one gas safety valve is connected in a preferably detachable manner, having at least one controllable valve in or at the valve block and at least one pressure accumulator holding the gaseous pressure medium, which pressure accumulator is also connected to the valve block in a detachable manner.

Such a safety system can be found in different hydraulic supply systems and is known for instance from the product catalog “Speichertechnik” (storage technology) No. D 3.553.4/03.16 by HYDAC INTERNATIONAL. The known solution is used for filling and testing hydro-storage facilities having a so-called back-up version. For this purpose, the known valve block has various fluid ports, in particular for the connection of a filling and testing device, a pressure gauge, downstream nitrogen cylinders, a pressure accumulator in the form of a hydraulic accumulator and at least one gas safety valve. During operation of the valve block, the gas end of the hydraulic accumulator, preferably in the form of a piston accumulator, is permanently connected to the gas safety valve. The liquid end of the hydraulic accumulator, which is separated from the gas end by a separating element, such as a separating piston, which can be moved longitudinally in a storage housing, is connected to a hydraulic supply system, for instance in the form of a conventional hydraulic circuit. Further, there is a shut-off valve in the valve block, which shut-off valve in its open position opens the fluid path between the possibly connected, downstream nitrogen cylinders and the hydraulic accumulator for a gas-conveying connection to the nitrogen gas and which, in its closed position, blocks this fluid path.

When removing the gas safety valve from the valve block, for instance, in the context of maintenance or repair work, then the pressurized working gas has to be completely vented from the safety system every time, wherein the individual connected hydraulic accumulator and/or the individual connected nitrogen cylinders have to be closed and at least parts of a connected hydraulic system must be depressurized accordingly. Upon subsequent recommissioning of the safety system, including the assigned gas safety valve and correspondingly connected pressure accumulators, the above-mentioned decommissioning steps have to be reversed.

Based on this prior art, the invention addresses the problem of providing a safety system having improved functionality and conserving resources.

A safety system having the features of patent claim 1 in its entirety solves this problem. Advantageous embodiments of the invention are the subject of the dependent claims.

A particularly high level of safety is achieved because according to the characterizing part of claim 1, a gas-conveying connection routed at least partially within the valve block between the connected pressure accumulator and the connected gas safety valve can be opened or blocked by means of the valve. The individual gas safety valve can be removed from the valve block if necessary, provided that the assigned valve in or at the valve block is brought into its blocking position and is safely separated from the gas end of the connected gas pressure accumulator, which is composed of a hydraulic accumulator or a gas reservoir, such as a nitrogen cylinder or any other, at least partially gas-holding pressure vessel, such as a storage tank or the like.

The safety system according to the invention provides the option of shutting off the gas safety valve connected to the valve block of the safety system via an assigned controllable valve without suffering substantial gas losses at the end of the pressure accumulator system connected to the valve block and without depressurizing any components of the hydraulic system.

The required removal of a gas safety valve from the valve block of the safety system required during repair and/or maintenance work can be performed quickly and inexpensively and any time-consuming emptying and filling procedures at the gas end of a connected system having the pressure accumulator can be omitted, which conserves resources. This is without parallel in the prior art.

Pressure accumulators according to the invention include all containers, such as pressure vessels, hydraulic accumulators, gas cylinders, in particular nitrogen cylinders, and the like, suitable and used for receiving a fluid, in particular a gas. It goes without saying that the accumulator used in the safety system according to the invention is not limited to the usual language definitions in individual areas.

In a preferred embodiment of the safety system according to the invention, the pressure accumulator is a pressure vessel, which is or can be filled exclusively with the gaseous pressure medium, such as a nitrogen cylinder or a hydraulic accumulator, in particular designed as a bellows, membrane, storage or piston, whose separator accommodated in a storage housing separates a gas end from a liquid end. In this way, various types of pressure accumulators, which are only connected to one valve block, can be safely operated and controlled based on only one safety system, which is regularly the case, when at least one hydraulic accumulator is connected as a pressure accumulator to a hydraulic system at one end of the valve block and additional nitrogen cylinders are connected as storage or downstream cylinders at the same or another end of the valve block, which cylinders can, for an established fluid supply, be used to recharge the hydraulic accumulator at its gas end even in operation or increase its prestress at its gas end in operation.

In a further preferred embodiment of the safety system according to the invention, at least two gas safety valves are connected to the valve block, wherein a safety device ensures that the gas-conveying connection to each connected pressure accumulator is interrupted before a gas safety valve is removed from the valve block, and the connection leading to at least one other gas safety valve is maintained such that a permanent gas-conveying connection between this individual pressure accumulator and this other gas safety valve is established during the replacement of the one gas safety valve and its re-commissioning. In this way, the operation of a hydraulic, at least partially gas-conveying plant can be maintained, even if a gas safety valve is removed from the valve block, because the gas safety valve remaining at the valve block for safety reasons fully takes over the addressed safety functions.

The safety system according to the invention in particular ensures that during commissioning and continuous operation of a hydraulic supply system, the gas safety valve set to maximum response pressure remains permanently connected to the gas end of the pressure accumulator, whose liquid end remains connected to a hydraulic system or equipment, for instance in the form of a hydraulic accumulator. In particular, for a plurality of gas safety valves used at the valve block, for cleaning and/or maintenance of such a gas safety valve, the latter can be removed from the valve block, while the other gas safety valve remaining at the valve block takes over the safety function described for the hydraulic supply system and its equipment. Generally, such gas safety valves are composed of pressure relief valves, whose gas outlet end leading to the environment is covered by a mesh grid or a sieve to protect any persons in the vicinity from being affected by the outflow of compressed gas of high pressure in the event of a safety incident.

In a preferred embodiment of the safety system according to the invention, the safety device is based on a mechanical locking system, a mechanical control system, an electrical monitoring system or a chip-controlled actuation system for the relevant controllable valve. Due to the design of the safety device that is based on the requirements of and adapted to the particular application, a secure shut-off of the pressure accumulator, having a low susceptibility to failure and fault, is ensured in operation, for instance, before an assigned gas safety valve is removed. Mechanical systems for locking or controlling the valve have the advantage of high robustness and low maintenance requirements. An electrical or chip-controlled system for monitoring or actuation offers the advantage of a small footprint and the option of remote monitoring when using suitable data transmission.

In a further preferred embodiment of the safety system according to the invention, two, preferably manually operated, ball valves are provided to implement a mechanical locking system, which ball valves are each connected to an assigned gas safety valve in a gas-conveying manner and which bear control disks ensuring in the mutually locked state that a ball valve in its open position connects the assigned gas safety valve to the pressure accumulator via a gas-conveying connection and the other ball valve in its blocking position blocks an assigned other connection to the relevant pressure accumulator for the removal of the assigned gas safety valve from the valve block, for instance, for replacement or maintenance purposes.

The control disks are an integral part of a mechanical lock of the actuating elements of the ball valves and preferably arranged at an outer end of the valve block. Once a ball valve is blocked to remove the assigned gas safety valve, the assigned control disk is interlocked with at least one control disk of a further gas safety valve that the further gas safety valve is blocked in the open, safe operating position and held securely. Thus, when dismounting and removing one gas safety valve, at least one further functional gas safety valve is connected to the valve block in its open position, which then performs solely the safety function.

In a further preferred embodiment of the invention, one of the control disks can, starting from a common opening direction, be actuated in the direction of a closed position of the ball valve by means of two hand levers of the ball valves, the outer peripheral end of which control disk has a cutout, which interacts with a correspondingly shaped cutout at the outer periphery of the other control disk such that a rotational movement of the respective ball valve is enabled or blocked by means of the assigned hand lever. Particularly preferably, the respective cutout has an arcuate contour with a curvature comparable to the outer circumference of the control disk. The other control disk engages with a cutout shaped in that way such that the assigned hand lever is blocked in the selected position and an unintentional or deliberate change of this position is not possible.

The gas safety valves have a basic cylindrical shape and are arranged at an underside of the valve block. The hand levers for actuating the assigned ball valves are preferably arranged at an end of the valve block accessible to an operator, wherein as a rule a vertical direction indicates the open position and a horizontal direction indicates the closed position of the assigned ball valve. Particularly preferably, the cutouts in adjacent hand levers are arranged such that in the open position of the two hand levers, the cutouts are arranged next to each other and opposite from each other such that upon movement of one hand lever into the closed position, the assigned control disk is moved into the cutout at the other control disk of the other hand lever thereby blocking its movement in the closed position as well.

Preferably, two or more gas safety valves are arranged next to each other, at the valve block, forming a row. Accordingly, two or more hand levers having assigned control disks are arranged next to each other, at the side of the valve block, forming a row.

It is also advantageous that the control disk interacts with a stop limit at the valve block such that the hand lever can be pivoted from an opening direction parallel to the longitudinal direction of the relevant gas safety valve by 90° to a blocking position transverse to this longitudinal orientation and vice versa. This results in the advantage of error-free operation when pivoting the relevant hand lever in one of its positions.

In a further preferred embodiment of the safety system according to the invention, a 3-way ball valve is used as a controllable valve to implement a mechanical control system, which ball valve in its one control position connects a gas safety valve via a connection to the pressure accumulator in a gas-conveying manner and decouples another gas safety valve from the pressure accumulator by blocking an assigned further connection, wherein in a further control position, the other gas safety valve is connected to the pressure accumulator via the other connection in a gas-conveying manner and the one gas safety valve is decoupled by blocking the one connection. By using only one 3-way ball valve, two separate ball valves for the two gas safety valves can be dispensed with. Regardless of the control position of the 3-way ball valve, one gas safety valve is then connected to the pressure accumulator and one gas safety valve is disconnected therefrom, i.e. at least one gas safety valve always takes over the safety function of the pressure accumulator.

In a further preferred embodiment of the safety system according to the invention, the open and closed positions of the controllable valve are monitored by means of sensors for the implementation of an electric monitoring system, and a higher-level control only permits the hydraulic supply system to operate, if the sensor system detects that the relevant gas-conveying connection between the gas safety valve and pressure accumulator via the controllable valve is actually open and communicates this fact to the controller. This results in the advantage that an opening or locking of the gas-conveying connection can be “automatically” detected. By means of an additional optical display, for instance attached to an outside of the valve block, an operator can be notified of the enabling for the removal of the gas safety valve when the other gas safety valve performs the safety function.

In a further preferred embodiment of the safety system according to the invention, a control chip is provided for the implementation of a chip-controlled actuation system, which permits the operation of the control system of the hydraulic supply system if deployed there, but which stops the supply system if it is removed and upon its deployment at the controllable valve decouples the relevant assignable gas safety valve from the pressure accumulator at the gas end by blocking the assigned connection. Conversely, an operation of the hydraulic supply system is only possible when the control chip returns the gas safety valve back to its open position after removal and this chip re-deployed at the controller permits the resumption of the operation of the connected hydraulic system.

It is also advantageous that the valve block has at least one further supply port, to which at least one further pressure accumulator, preferably a gas pressure accumulator, can be connected, which in its open position is connected to the relevant pressure accumulator, preferably to the gas end of a hydraulic accumulator, in a gas-conveying manner via a check valve arranged within the valve block. In particular, gas can then be taken from the gas supply of the storage cylinder via the further supply port and directed to the gas end of the hydraulic accumulator in order to increase the working capacity of this hydraulic accumulator.

It is also advantageous that the valve block has at least one further port, to which a filling and testing device can be connected, which is connected directly to the pressure accumulator via a filling and test port in the valve block in a gas-conveying manner, preferably connected to the gas end of a hydraulic accumulator in the form of a piston accumulator, and that this filling and test port is connected to a further connection between the further pressure accumulator and the pressure accumulator via a check valve, which opens in the direction of the respective controllable valves. Characteristics of the gas, such as temperature and pressure of the gas volume, can be monitored and recorded by the filling and testing device.

If a hydraulic supply system is connected to the above-mentioned hydraulic accumulator in a conventional manner at its liquid end, the safety system according to the invention ensures that in case of malfunction, for instance caused by a fire, no unintentional pressure increases can occur at the gas end of hydraulic accumulator because the open valve device or the ball valve in the open position ensures that gas can be directly vented to the outside if the pressure at the hydraulic accumulator end exceeds the maximum pressure set at the relevant gas safety valve. In this way, excessive pressure at the liquid end of the hydraulic accumulator and at the end of the supply system, which could result in the bursting of system parts, is immediately vented, such that the operators at the system components of the supply system are not exposed to hazards. The safety system further ensures that manual maloperation, which could result in an unwanted shutdown of the function of the gas safety valve, is impossible.

Further advantages and features of the invention will become apparent from the figures and the description of the drawing below. The above-mentioned features and the further cited features according to the invention can be implemented individually or in any combination at a safety system according to the invention and for the designated use. The features shown in the figures are purely schematic and not to scale.

### IN THE FIGURES

FIGS. 1a to 1c each show a side view of an exemplary embodiment of a valve block of a safety system having different operating positions of hand levers assigned to individual gas safety valves;

FIG. 2 shows a perspective view of the valve block of FIG. 1b;

FIGS. 3a and 3b each show a circuit diagram of a first exemplary embodiment of the safety system according to the invention;

FIG. 4 shows a circuit diagram of a second exemplary embodiment of the safety system according to the invention;

FIG. 5 shows a circuit diagram of a third exemplary embodiment of the safety system according to the invention;

FIG. 6 shows a circuit diagram of a fourth exemplary embodiment of the safety system according to the invention; and

FIGS. 7a and 7b each show a perspective view of a further exemplary embodiment of the safety system according to the invention.

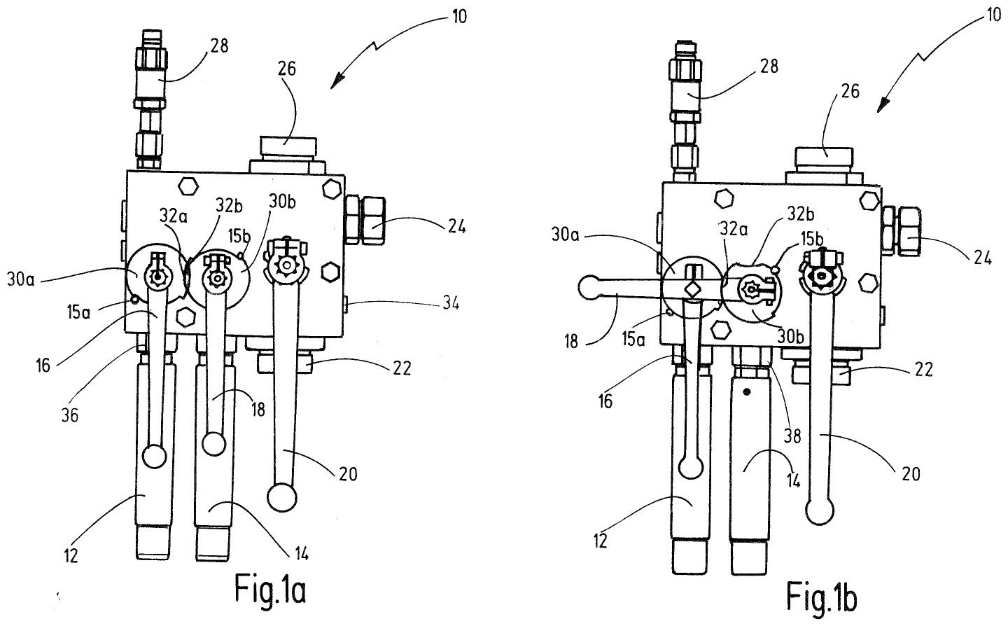

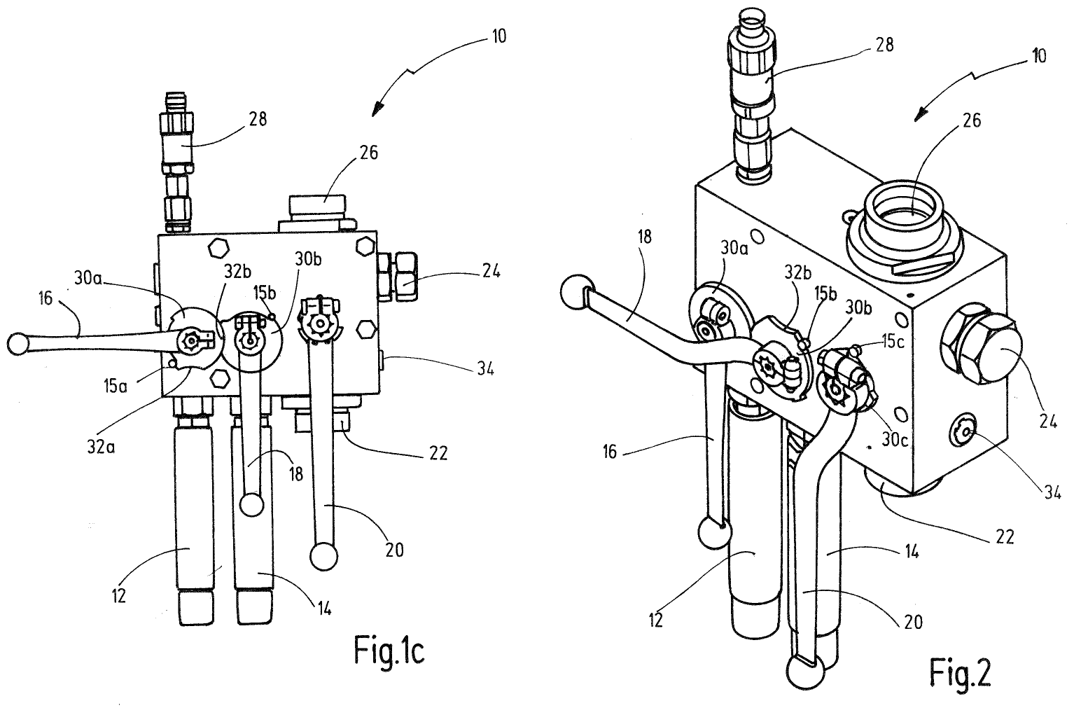

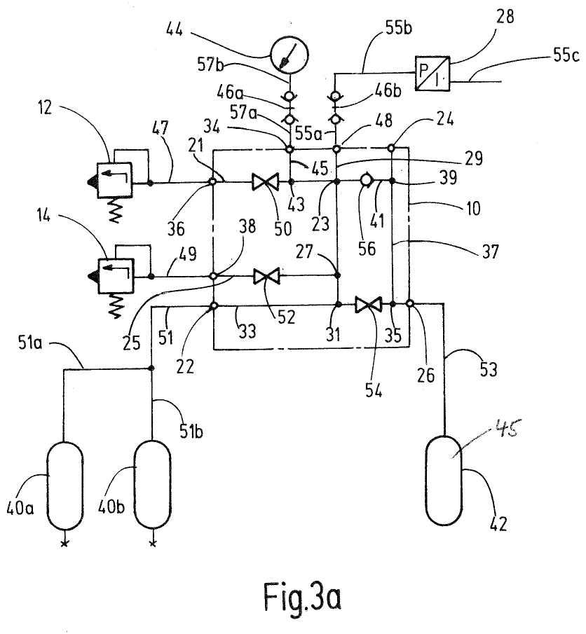

FIGS. 1a to 1c respectively show a side view of a valve block 10, at the underside of which a first gas safety valve 12 and a second gas safety valve 14 are arranged. One ball of a ball valve 50, 52 each (see FIG. 3a,b) present in the housing of the valve block 10 is assigned to the respective gas safety valves 12, 14. The balls of the ball valves 50, 52 can be alternatively switched back and forth between an open control position and a blocked control position using a first hand lever 16 and a second hand lever 18, respectively. In the control position of the two hand levers 16, 18 shown in FIG. 1a, these are each oriented in the vertical direction, parallel to the cylindrical gas safety valves 12, 14, and thus shown in their open control positions. In the closed control position, the assigned hand lever 16 or 18 is aligned horizontally, as FIG. 1b shows for the second hand lever 18 and FIG. 1c for the first hand lever 16. While the hand lever 16 has a straight shape, the other hand lever 18 has a crank to swivel it over the hand lever 16 if necessary (see FIG. 2). In the closed control position or closed position, the connection to the gas end 45 of a pressure accumulator 42 (see FIGS. 3a and 3b), not shown in FIGS. 1a to 1c, is disconnected by the assigned ball valve 50 or 52 and the removal of the assigned gas safety valve 12 or 14 becomes possible in a safe manner, which will be explained in more detail below.

A third hand lever 20 is arranged at the outside of the valve block 10 spaced apart from the hand levers 16, 18 arranged next to each other, which hand lever can be used to actuate a ball of a further third ball valve 54 (see FIGS. 3a,b) assigned to a supply port 22. The connection 22 is arranged in the direction of the FIGS. 1a,b,c and 2 at the bottom of the cubical valve block 10. In an end surface of the valve block 10 shown at the right in FIGS. 1a to 1c, a filling and test port 24 is formed for a gas-end filling and testing device, not shown further, and at the top of the valve block 10 there is a pressure port 26 for a connection of the pressure accumulator 42. Further, a measuring device 28 in the form of an electrical pressure transducer is provided at the upper end of the valve block 10. A pressure gauge connection 34 for a pressure gauge 44 (see FIGS. 3a to 6) is formed at the end surface of the valve block 10 shown at the right in FIGS. 1a to 1c. The first and the second hand lever 16, 18 are each connected to circular control disks 30a, 30b, which are each arranged coaxially to the axis of rotation of the assigned hand levers 16, 18 at the front face of the valve block 10. The third hand lever 20 has a conventional disk 30c for limiting rotation.

The annular control disks 30a, 30b for the hand lever 16, 18 each have a segmented, concave-shaped cutout 32a, 32b having an arcuate contour. The two cutouts 32a, 32b are arranged opposite one another in the opened control position of the two hand levers 16, 18 shown in FIG. 1a.

The configuration and arrangement of the cutouts 32a, 32b is selected such that upon movement of the second hand lever 18 clockwise into the closed control position, comparable to the illustration of FIG. 1b, the convex outer contour of the second control disk 30b at the outer peripheral end is inevitably moved into the first concave recess 32a of the first control disk 30a of the first hand lever 16. As a result, in the open, vertical control position shown, the first hand lever 16 is mechanically locked by the control disks 30a, 30b. Similarly, the first control disk 30a having a convex or arcuate outer circumference is moved, as shown in FIG. 1c, clockwise to the closed control position into the second, concave cutout 32b at the second control disk 30b when the first hand lever 16 is moved and accordingly the second hand lever 18 is securely locked in the open, vertical control position shown in FIG. 1c.

Further two pin-like projecting stop limits, 15a, 15b are provided at the valve block 10, each defining the rotational movement of the respective assigned hand levers 16, 18 by 90° in the open and the closed control positions and interacting with stop lugs arranged adjacent to the cutouts 32a, 32b of the respective control disks 30a, 30b. The pertinent stop limit is common in ball valves, i.e. they will not be discussed further in this context; in particular, individual details have been omitted in the figures for purposes of clarity. FIG. 2 also shows a limit stop 15c for a lug formed at the control disk 30c, which limits the corresponding rotational movement of the third hand lever 20.

FIG. 3a shows a hydraulic circuit diagram of a first exemplary embodiment of the valve block 10 having a first valve port 36 (see FIG. 1a) for the first gas safety valve 12 and a second valve port 38 (see FIG. 1b) for the second gas safety valve 14. At the supply port 22, two further pressure accumulators 40a, 40b, designed as gas accumulators in the form of conventional nitrogen recharging cylinders, are connected to the valve block 10, by way of example. Further, a pressure accumulator 42, formed as a pressure vessel exclusively filled with a gaseous pressure medium in the form of a nitrogen cylinder, is connected to the pressure port 26. The pressure gauge 44 is connected to the pressure gauge port 34 and the measuring device 28 is connected to a measuring port 48. The pressure gauge 44 and the measuring device 28 of conventional design are connected to the assigned terminals 34 and 48 of the valve block 10 in a fluid and pressure conveying manner via quick-release couplings 46a, 46b. The solution according to FIG. 3a can be used to, among other things, recharge the pressure accumulator 42 with nitrogen from the recharging cylinders 40a, 40b. The filled reservoir 42 can then be taken filled from the valve block 10 and a new reservoir 42 can be filled again. In that regard, a supply network (not shown) could also replace the individual storage cylinders 40a, 40b, which supply network can then be used to fill the reservoir 42. Instead of a pressure accumulator 42 in the form of a gas storage cylinder as shown by way of example, a plurality of such gas-conveying storage systems can also be connected to the connection 26 of the valve block 10 (not shown).

In the valve block 10, a plurality of interconnected fluid connections is formed between the first valve port 36, the second valve port 38, the supply port 22, the pressure port 26, the filling and testing port 24, the measuring port 48 and the pressure gauge port 34. Typically, the connections are introduced as drilled holes in the valve block 10 made of a metal material. From the first valve port 36, a first connection section 21 leads to a first intersection point 23, from the second valve port 38 a second connection section 25 leads to a second intersection point 27. The first intersection point 23 and the second intersection point 27 are arranged in a third connection section 29, which extends in the interior of the valve block 10 from the measurement connection 48 to a third intersection point 31.

A fourth connection section 33 runs from the supply port 22 to the pressure port 26. The third intersection point 31 and a fourth intersection point 35 are arranged in the fourth connection section 33. The fourth intersection point 35 is the end of a filling and test connection 37 beginning at the filling and test port 24. A fifth intersection point 39, which represents the end of a fifth connection section 41 beginning at the first intersection point 23, is arranged in the filling and test connection 37. A sixth intersection point 43 is arranged between the first valve port 36 and the first intersection point 22 in the first connection section 21, which sixth intersection point constitutes the end of a sixth connection section 45 beginning at the pressure gauge connection 34.

Further, there is a first line section 47 between the first gas safety valve 12 and the first valve port 36, a second line section 49 between the second gas safety valve 14 and the second valve port 38, third line sections 51, 51a, 51b between the further pressure accumulators 40a, 40b and the supply port 22, a fourth line section 53 between the pressure accumulator or gas storage cylinder 42 and the pressure port 26, fifth line sections 55a, 55b, 55c between the measuring device 28 and the measuring port 48 and continuing from the measuring device 28 and sixth line sections 57a, 57b between the pressure gauge 44 and the pressure gauge port 34.

In the connections leading from the gas safety valves 12, 14 to the pressure accumulator 42, the first ball valve 50 is arranged in the first connection section 21 and the second ball valve 52 is arranged in the second connection section 25. The third ball valve 54 is arranged between the third 31 and fourth intersection point 35 in the fourth connection section 33 leading to the pressure accumulator 42 and parallel thereto a check valve 56 is installed in the fifth connecting section 41 between the first 23 and fifth intersection points 39, which check valve opens in the direction of the first intersection point 23. The individual ball valves 50, 52, 54 are actuated individually by hand using the assigned hand levers 16, 18, 20. The filling and test connection 37 leads directly from the fourth intersection point 35 adjacent to the pressure port 26 to the filling and test port 24.

FIG. 3b is substantially identical to FIG. 3a and differs from the solution shown therein in that instead of a gas storage cylinder 42 designed as a pressure vessel, a pressure accumulator 42 designed as a hydraulic accumulator in the form of a piston accumulator is connected to the pressure port 26 of the valve block 10. In the illustration of FIG. 3b, a hydraulic supply system 43 is connected to the hydraulic or liquid end 47 of the pressure accumulator 42 designed as a piston accumulator, generally consisting of a hydraulic circuit, such as a motor-pump unit, a storage tank, hydraulic loads, control and monitoring devices, etc. (not shown).

As soon as the pressure at the gas end 45 of the pressure accumulator 42 increases due to an impermissible pressure increase, for instance caused by a technical fault in the hydraulic supply system 43, such as a fire, beyond a maximum pressure at the gas end 45 of the pressure accumulator 42, which maximum pressure is preset by the set pressure of the gas safety valves 12, 14, causes their triggering and gas can flow from the gas end 45 of the pressure accumulator 42 when the valves in the form of ball valves 50, 52 are open through the gas safety valves 12, 14, until their set pressure of, for instance, 330 bar again is reached or if the pressure has fallen below that value. This safety function is also implemented when the gas ends of the further pressure accumulators 40a, 40b are separated from the gas end 45 of the pressure accumulator 42 by closing the further third ball valve 54. In this case, the pressure compensation uses the check valve 56, which opens in the direction of the two gas safety valves 12, 14 and insofar opens the assigned connections in the valve block 10, which regularly vent working gas in the form of nitrogen gas, for the purpose of pressure reduction. For the sake of completeness, it should be mentioned that the piston 49 of the pressure accumulator 42 designed as a piston accumulator separates the gas end 45 from the liquid end 47 leading to the supply system 43. In the exemplary embodiment of the safety system shown in FIGS. 3A and 3b, the separately operable and switchable ball valves 50, 52 ensure that one of the gas safety valves 12 or 14 is always connected to the pressure accumulator 42 in a gas-conveying manner via the assigned connection, which results in the desired increase in safety as explained above.

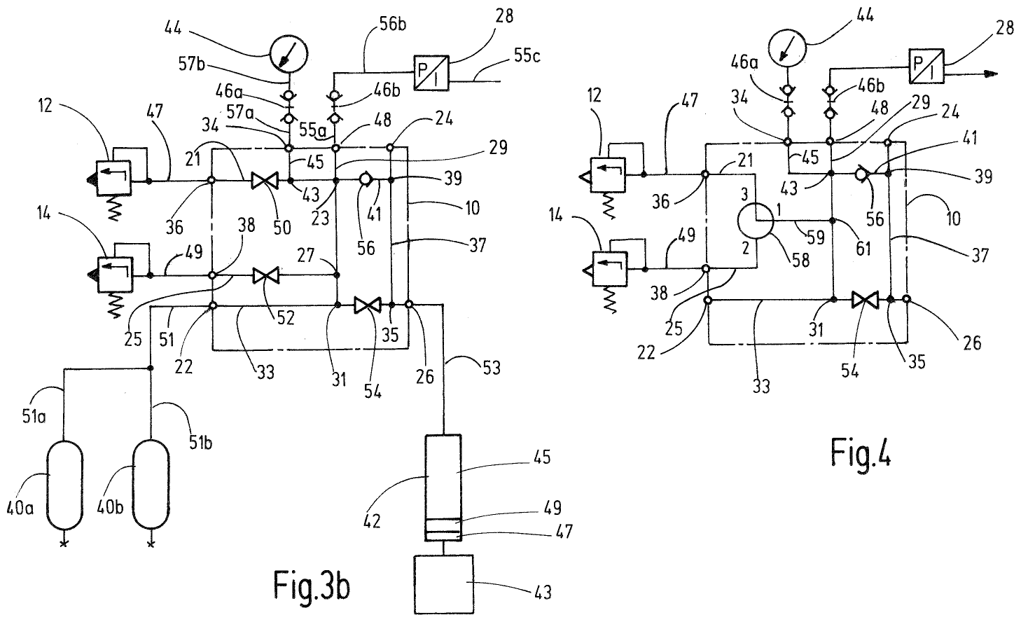

The circuit diagram shown in FIG. 4 for a second exemplary embodiment of the safety system differs from the first exemplary embodiment shown in FIGS. 3a and 3b in that instead of the two ball valves 50, 52, only one 3-way ball valve 58 is arranged in the connections from the gas safety valves 12, 14 to the relevant pressure accumulator 42. Due to the arrangement of the 3-way ball valve 58, the interconnection of the connections in the valve block 10 is modified such that the first connection section 21 and the second connection section 25 each end at the ball valve 58 and a common connection section 59 leads from there to a common intersection point 61 in the third connection section 29. The pressure gauge 44 is also connected to the third connection section 29 via the sixth connection section 45. The interconnection of the fourth connection section 33, the fifth connection section 41 and the filling and test port 37 is [symbol] unchanged. The pressure accumulators 40a, 40b, 42 are no longer shown in FIG. 4 for the sake of simplicity. Also, the cylinders 40a, 40b do not necessarily have to be connected to the terminal 22, which has to be closed if not in occupied. The safety functions based on the two gas safety valves 12, 14 and the assigned ball valves 50, 52 is also reduced if only one corresponding pressure accumulator 42 is connected to the port 26 of the valve block 10. Regardless of the rotational position of the ball of the ball valve 58, however, in the 3-way ball valve solution one gas safety valve 12 or 14 is in any case is connected to the pressure accumulator 42 in a gas-conveying manner. Dangerous operating errors are impossible just like in the previously described solutions.

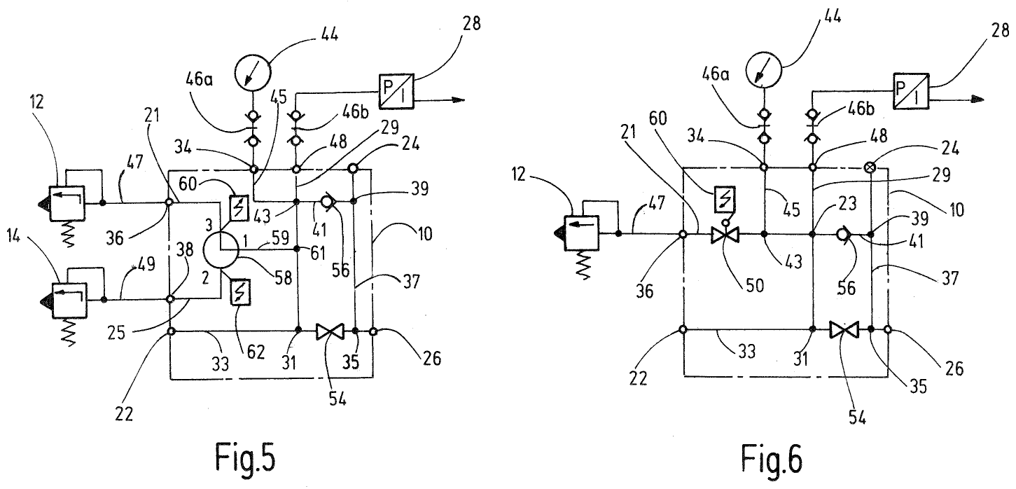

In the diagram shown in FIG. 5, in the manner of a hydraulic circuit diagram for a third exemplary embodiment of the safety system, a first monitoring device 60 is provided in the first connection section 21 for the electrical or electronic monitoring of a connection from the first gas safety valve 12 to the pressure accumulator 42 and a second comparable monitoring device 62 is provided in the second connection section 25 for monitoring the other connection from the second gas safety valve 14 to the pressure accumulator 42 at the ports 3, 2 of the 3-way ball valve 58. Otherwise, the illustration of FIG. 5 essentially corresponds to the illustration according to FIG. 4.

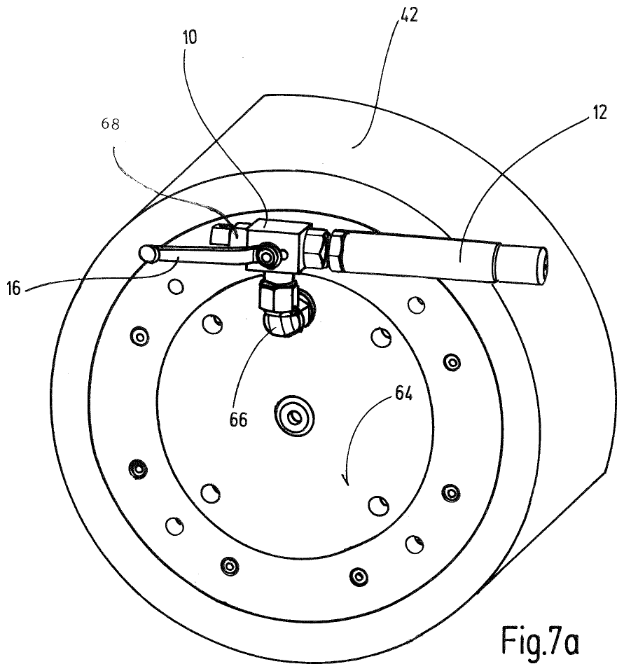

In the circuit diagram shown in FIG. 6 for a fourth exemplary embodiment of the safety system only one gas safety valve 12 and only one monitoring device 60 are provided, as shown above, in the first connection section 21 for monitoring the one connection from the gas safety valve 12 to the pressure accumulator 42 at the assigned ball valve 50. This monitoring device 60 can optionally electrically or electronically monitor the opening and/or closed position of the ball valve 50. The illustration of FIG. 6 differs from the first exemplary embodiment shown in FIGS. 3a and 3b in particular in that the second gas safety valve 14, the second line section 49, the second valve port 38, the second connection section 25 together with the second intersection point 27 and the second ball valve 52 can be dispensed with.

In the embodiments of the safety system shown in FIGS. 3a, 3b and 4, a redundant mechanical locking or valve control system is implemented. In the mechanical locking system according to FIGS. 3a and 3b, the two assigned 2-way ball valves 50, 52 can be mutually locked in the direction of their respective horizontal closed positions using the control disks 30a, 30b, such that only one ball valve 50 or 52 can enter its blocking position, which disables the gas-conveying safety function for only one of the two connected gas safety valves 12 or 14. In the valve control system according to FIG. 4, an operator guidance is achieved in the sense that, regardless of the operator's intention, viewed from the valve position of the valve 58, one gas safety valve 12, 14 is always kept in its safety function in any case.

In the exemplary shown in FIGS. 5 and 6, an electrical or electronic monitoring system is implemented based on at least one monitoring device 60, 62 at the 3-way ball valve 58 or at a ball valve 50. It goes without saying that combinations of such a monitoring system according to FIGS. 5 and 6 with a mechanical locking or valve control system according to FIGS. 3a, 3b and 4 at the valve block 10 can be combined with one another for reasons of redundancy.

Once a gas safety valve 12, 14 is to be removed from the valve block 10, it must first be ensured that the relevant gas-conveying connection has been disconnected or shut off by the gas safety valve 12, 14 using the valve ports 36, 38 and the respective assigned ball valve 50, 52 or 58 and the pressure port 26 of the pressure accumulator 42. This is achieved by actuating the assigned hand lever 16, 18 and an assigned mechanical locking of the control disks 30a, 30b formed at the hand levers 16, 18 or via an appropriate setting of one of the two control positions of the 3-way ball valve 58. In the valve solution using a ball valve 58, an externally actuated control would also be conceivable, for instance. in the form of an electric, hydraulic or pneumatic motor control. Alternatively, or additionally, the blocking of the gas connection from the gas safety valve 12, 14 to the relevant pressure accumulator 42 can be monitored using at least one monitoring device 60, 62, wherein the monitoring devices 60, 62 generate an appropriate control and/or monitoring signal for a higher-level control device (not shown). Correspondingly, the active replacement of a gas safety valve 12, 14 by hand can be monitored at the valve block 10 and the valves 50, 52, 58 can be brought into the opening or closing control position as required.

As soon as the fourth connection section 33 is shut off from the pressure accumulator 42 to the gas safety valves 12, 14 using the third ball valve 54, the gas end 45 of the relevant pressure accumulator 42 can be checked and optionally refilled using a filling and testing device 28 (not shown) to be connected to the filling and test port 24. If refilling or adding working gas from the gas supply of the further pressure accumulators 40a, 40b is required, the third ball valve 54 is permanently opened, so that the working gas can flow from the gas supply of the further pressure accumulators 40a, 40b to the supply port 22 via the third line sections 51, 51a, 51b, further to the pressure port 26 via the fourth connection section 33 and further to the pressure accumulator 42 via the fourth line section 53 if necessary. The assigned pressure curve can be monitored using the pressure gauge 44 connected to the pressure gauge port 34.

Furthermore, the pressure in the safety system can be monitored electrically using the pressure transducer 28. If the gas supply in the respective further pressure accumulators 40a, 40b also has to be filled, assuming that the further pressure accumulators 40a, 40b are also connected to the valve block 10 via the port 22, this happens simultaneously with the gas end 45 of the relevant pressure accumulator 42 for an open ball valve 54 and if required for a closed ball valve 54 using the check valve 56. The pertinent filling using the port 24 then continues until the self-adjusting pressure equilibrium between the further pressure accumulators 40a, 40b, the refilling device at the port 24 and the relevant pressure accumulator 42 causes the non-return valve 56 to increasingly reach its closed position.

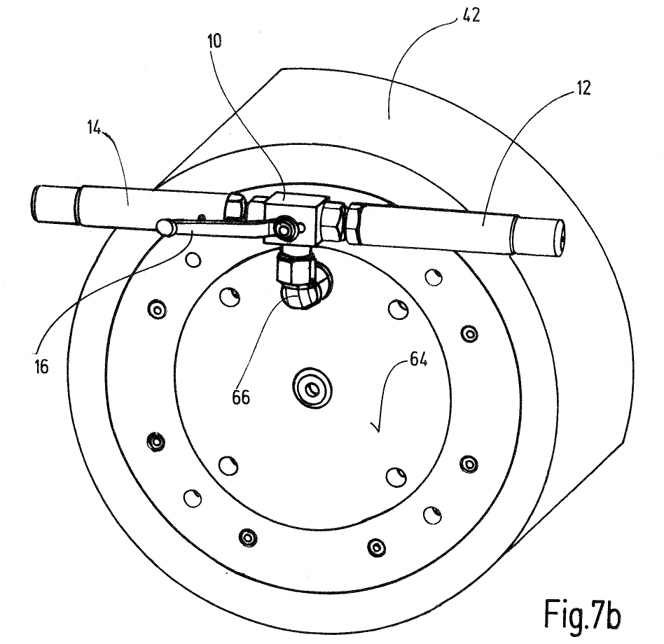

An alternative embodiment of the safety system according to the invention is shown in FIGS. 7a and 7b. The valve block 10 is designed comparatively small compared to the exemplary embodiment shown in FIGS. 1a to 1c and encloses a 3-way ball valve, not shown in the perspective view of FIGS. 7a and 7b. The ball valve can be actuated between its control positions using a hand lever 16 rotatably mounted at the valve block 10. The valve block 10 and the components arranged thereon form a separate structural unit, which is arranged at an end face 64 of a pressure accumulator 42. For this purpose, a right-angled connector 66 is inserted into a passage opening at the end face 64, wherein the valve block 10 is firmly connected to the connecting piece 66.

In the first variant of the safety system shown in FIG. 7a, a gas safety valve 12 and a burst disk 68 are arranged at the valve block 10. There, the gas safety valve 12 and the burst disk 68 are aligned horizontally and arranged at opposite sides of the valve block 10. The burst disk 68 has the function that, when the gas safety valve 12 is connected, it is kept free from damage by excessively high-pressure loads due to the rupture of the burst disk 68. The 3-way ball valve arranged in the valve block 10 can be used to block or open a gas-conveying connection between the gas safety valve 12 and the pressure accumulator 42. The 3-way ball valve has an L-shaped or T-shaped drilled hole, wherein the central connection leads to the pressure accumulator 42 and the gas safety valve 12 and/or the rupture disk 68 are attached at the respective other ports.

The second variant of the safety system illustrated in FIG. 7b differs from the first variant shown in FIG. 7a in that, instead of the burst disk 68, a second gas safety valve 14 is arranged at the valve block 10. This results in the advantage that upon removal of one of the two gas safety valves 12, 14 by the other gas safety valve 14, 12 remaining at the valve block 10, a continuous safety function is ensured.

1. A safety system comprising a valve block (10) to which at least one gas safety valve (12, 14) is connected in a preferably detachable manner, having at least one controllable valve (50, 52, 58) in or at the valve block (10) and having at least one pressure accumulator (42) holding a gaseous pressure medium, which pressure accumulator is connected to the valve block (10) in a likewise detachable manner, characterized in that a gas-conveying connection routed at least partially within the valve block (10) between the connected pressure accumulator (42) and the connected gas safety valves (12, 14) can be opened or blocked by means of the valve (50, 52, 58).

2. A safety system according to claim 1, characterized in that the pressure accumulator (42) is a pressure vessel, which is or can be filled exclusively with the gaseous pressure medium, or a hydraulic accumulator, whose separator accommodated in a storage housing (49) separates a gas end (45) from a liquid end (47).

3. A safety system according to claim 1, characterized in that at least two gas safety valves(12, 14) are connected to the valve block (10), and that a safety device ensures that the gas-conveying connection to each connected pressure accumulator (42) is interrupted before a gas safety valve (12, 14) is removed from the valve block (10), and the connection leading to at least one other gas safety valve (12, 14) is maintained such that a permanent gas-conveying connection between this individual pressure accumulator (42) and this other gas safety valve (12, 14) is established during the replacement operation of the one gas safety valve (12, 14) and its re-commissioning.

4. The safety system according to claim 1, characterized in that the safety system is based on a
mechanical locking system,
mechanical control system,
electrical monitoring system, or
chip-controlled actuation system for the respective controllable valves (50, 52, 58).

5. The safety system according to claim 1, characterized in that two, preferably manually operated, ball valves(50, 52) are provided to implement a mechanical locking system, which ball valves are each connected to an assigned gas safety valve (12, 14) in a gas-conveying manner and which bear control disks (30a, 30b) ensuring in the mutually locked state that a ball valve (50) in its open position connects the assigned gas safety valve(12) to the pressure accumulator (42) via a gas-conveying connection and the other ball valve (52) in its blocking position blocks an assigned other connection to the relevant pressure accumulator (40a, 40b, 42) for the removal of the assigned gas safety valve (14) from the valve block (10), for instance, for replacement or maintenance purposes.

6. The safety system according to claim 1, characterized in that one of the control disks (30a, 30b) can, starting from a common opening direction, be actuated in the direction of a closed position of the ball valve (50, 52) by means of two hand levers (16, 18) of the ball valves (50, 52), the outer peripheral end of which control disk has a cutout (32a, 32b), which interacts with a correspondingly shaped cutout (32a, 32b) at the outer periphery of the other control disk(30a, 30b) such that a rotational movement of the respective ball valves (50, 52) is enabled or blocked by means of the assigned hand lever (16, 18).

7. The safety system according to claim 1, characterized in that the control disk (30a, 30b) interacts with a stop limit (35a, 35b) at the valve block (10) such that the hand lever (16, 18) can be pivoted from an opening direction parallel to the longitudinal direction of the respective gas safety valve (12, 14) by 90° to a blocking position transverse to this longitudinal orientation and vice versa.

8. The safety system according to claim 1, characterized in that a 3-way ball valve (58) is used as a controllable valve to implement a mechanical control system, which ball valve in its one control position connects a gas safety valve (12) via a connection to the pressure accumulator (42) in a gas-conveying manner and decouples another gas safety valve (14) from the pressure accumulator (42) by blocking an assigned further connection, wherein in a further control position, the other gas safety valve (14) is connected to the pressure accumulator (42) via the other connection in a gas-conveying manner and the one gas safety valve (12) is decoupled by blocking the one connection.

9. In a further preferred embodiment of the safety system according to the invention, the open and closed positions of the respective controllable valves (50, 58) are monitored by means of sensors (60, 62) for the implementation of an electric monitoring system, and a higher-level control only permits the hydraulic supply system to operate, if the sensors (60, 62) detects that the relevant gas-conveying connection between the gas safety valve (12, 14) and pressure accumulator (42) via the controllable valve (50, 58) is actually open and communicates this fact to the controller.

10. The safety system according to claim 1, characterized in that a control chip is provided for the implementation of a chip-controlled actuation system, which permits the operation of the control system of the hydraulic supply system if deployed there, but which stops the supply system if it is removed and upon its deployment at the controllable valve (50, 52, 58) decouples the relevant assignable gas safety valve (12, 14) from the pressure accumulator (42) at the gas end by blocking the assigned connection.

11. The safety system according to claim 1, characterized in that the valve block (10) has at least one further supply port (22), to which at least one further pressure accumulator(40a, 40b), preferably a gas pressure accumulator, can be connected, which in its open position is connected to the relevant pressure accumulator (42), preferably to the gas end (45) of a hydraulic accumulator, in a gas-conveying manner via a check valve (54) arranged within the valve block (10).

12. The safety system according to claim 1, characterized in that the valve block (10) has at least one further port (24) to which a filling and testing device (28) can be connected, which is connected directly to the pressure accumulator (42) via a filling and test port in the valve block (10) in a gas-conveying manner, and that this filling and test port is connected to a further connection between the respective further pressure accumulator (40a, 40b) and the respective pressure accumulator (42) via a check valve (56), which opens in the direction of the respective controllable valves (50, 52, 58).
